(19) United States
(12) Patent Application Publication
(10) Pub. No.: US 2014/0212542 A1
(43) Pub. Date: Jul. 31, 2014

(54) Method For Producing Gluten-Free Vodka From Gluten Sources

(71) Applicant: Manhoman Singh MINHAS, Christchurch (BB)

(72) Inventor: Manhoman Singh MINHAS, Christchurch (BB)

(21) Appl. No.: 13/843,036

(22) Filed: Mar. 15, 2013

Related U.S. Application Data
(60) Provisional application No. 61/759,050, filed on Jan. 31, 2013.

(51) Int. Cl. C12G 3/08

(52) U.S. Cl. CPC C12G 3/085
USPC 426/16

(57) ABSTRACT

A method of producing gluten-free vodka from a gluten grain source comprising the steps of: fermenting a wort produced from a gluten grain source to obtain a fermentate; cooling the fermentate; filtering the cooled fermentate through nano filtration and reverse osmosis filtration to obtain a purified fermentate; and then distilling said purified fermentate to obtain vodka 100% free of gluten.

### CROSS-REFERENCE TO RELATED APPLICATIONS

This application claims priority based on Application Ser. No. 61/759,050 filed Jan. 31, 2013, incorporated herein by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

Vodka is one of the most popular spirits sold and consumed in America, accounting for more than 20% of all distilled spirits sales and consumption. Vodka is a non-aged neutral spirit that can be distilled from potatoes, rye, wheat, barley, corn and many other fermentable materials.

The majority of vodka sold and consumed in the United States today, however, is not distilled by the bottler, rectifier or distributor. Most bottlers, rectifiers and distributors of vodka forego the distillation step, and instead purchase 190 proof grain neutral spirits (GNS) as a by-product of commercial continuous ethanol distillation plants. These bottlers, rectifiers and distributors simply add water and flavoring to the 190 GNS before bottling and reselling the product as vodka.

Post-distillation, purification is conventionally accomplished by filtration over charcoal. This method of production may be inefficient, as vodkas produced have significant amounts of undesirable alcohols and other products that are known to impart negative flavors, aroma and odors to the vodka and contribute to hangovers. As a result, conventional vodkas may be of low quality with poor taste and unwanted aroma and odor.

Moreover, vodka may contain gluten, which is an undesirable component for those suffering from celiac disease. Vodka made from non-gluten sources, such as potato vodka or grape vodka, is usually gluten-free. However, there is some controversy over whether vodka made from a gluten grain source is gluten-free. Most experts on celiac disease believe that distillation removes enough of the harmful gluten proteins to render alcohol made from gluten grains gluten-free. In fact, the National Institutes of Health advises that distilled alcoholic beverages are safe to drink, even if they're made from gluten sources. However, many patients who are very sensitive to gluten cross-contamination can have a reaction to vodka made from wheat or rye. The Celiac Sprue Association recommends against consuming gluten-based vodkas. For this reason, there is a need for a method of making a gluten-free vodka from a gluten grain source.

Various conventional techniques have been developed for the production of purified alcohol. Ultra filtration methods for obtaining beer are described in U.S. Pat. No. 5,618,572. A method for processing a wort stream used in the production of beer using at least one reverse osmosis and/or nano filtration membrane as a filter stage is disclosed in WO 99/47636. Filtration of a sugar solution through a nano filtration membrane and/or reverse osmosis membrane prior to fermentation is disclosed in U.S. Patent Publication No. 2011/0250637. A process for preparation of a wort from mash comprising introducing the mash into at least one membrane filtration unit for membrane filtration of the spent grain from the mash to form a clear wort is disclosed in U.S. Pat. No. 5,453,285. A method for producing a purified vodka by contacting ethyl alcohol with a carbon dioxide-containing gas is described in U.S. Pat. No. 3,930,042; by charcoal filtration is described in U.S. Pat. Nos. 2,946,687 and 5,370,891; and production of vodka by supercooling technology is described in U.S. Pat. No. 5,618,573.

However, a need still exists for a method of producing high quality vodka that contains low levels of undesirable alcohols, contaminants, aroma and is gluten-free. Also, need exists where distillers that use sugar cane juice, molasses, grains (barley, rye or wheat), grapes or fruits as the source of sugar to ferment to alcohol can also make a pure vodka that does not have the malty, grainy, apple musty or fruity aroma that comes through after they distil their fermented beer/wash. This will allow these spirit manufacturers to produce pure vodka in addition to other spirits they make, using the same feedstock as they use for other products.

The present invention fills the aforementioned need. In particular, the process of the present invention produces high quality vodka.

### BRIEF SUMMARY OF THE INVENTION

A method of producing gluten-free vodka from a gluten grain source comprising the steps of: fermenting a wort produced from a gluten grain source to obtain a fermentate; cooling the fermentate; filtering the cooled fermentate through nano filtration and reverse osmosis filtration to obtain a purified fermentate; and then distilling said purified fermentate to obtain vodka 100% free of gluten.

### BRIEF DESCRIPTION OF THE DRAWINGS

FIG. 1 is a schematic showing the method.

### DETAILED DESCRIPTION OF THE INVENTION

Vodka is a food product widely consumed throughout the world. Its quality, determined by organoleptic and physico-chemical properties, therefore is important. The basic technology of vodka production was developed in the last century with only minor changes introduced in more recent times.

The present method addresses the provision of desirable properties in vodka by utilizing the processes described in this description of the invention and the following examples.

Any source of sugar including, but not limited to barley, wheat, rye grain, corn, corn syrup, dextrose, sugar cane juice, molasses, refined sugar fruit juice or potatoes can be used for the wort to be fermented. More specifically, gluten grain sources are wheat, barley, rye and their derivatives. The term “wort” refers to a liquid formed from ground malted grain added to warm water.

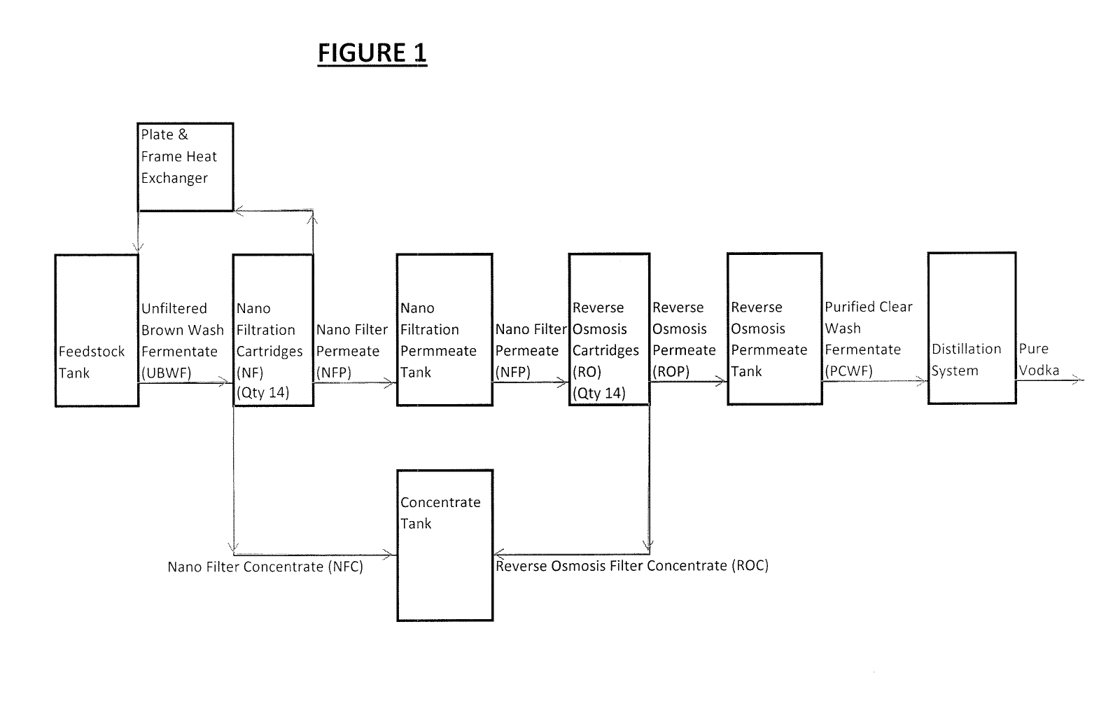

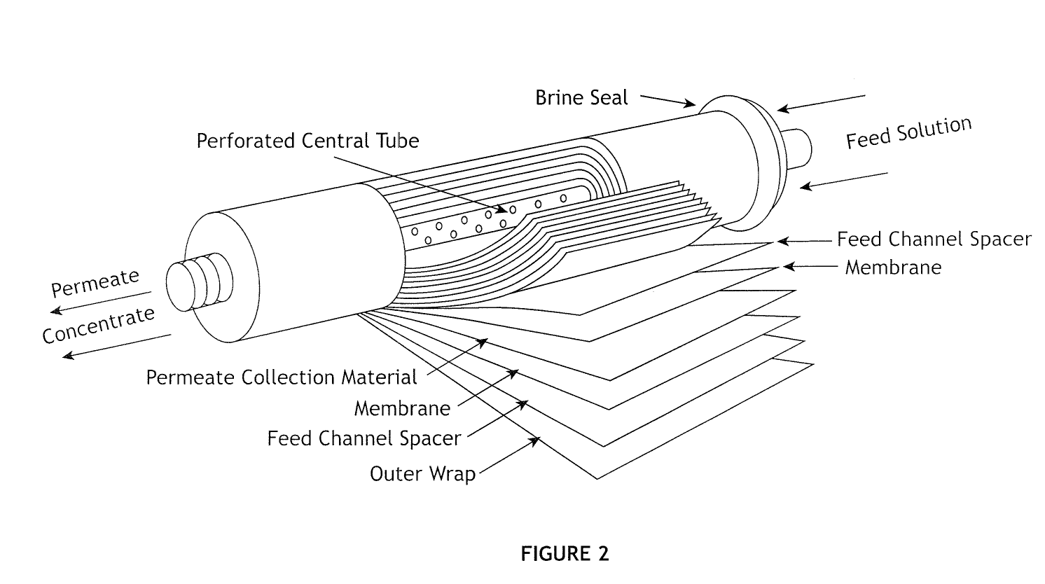

The sugar source chosen is fermented with yeast and addition of enzymes under controlled temperature conditions. Once the feed “beer/wash” is fermented, at reference numeral 1 in FIG. 1, it is then processed through the filtration system.

Nano filtration is a process which can separate particles between 0.005 and 0.001 microns and reverse osmosis can separate particles as small as 0.00005 microns. Nano filtration has a molecular weight cut-off of 700 Daltons and reverse osmosis has a molecular weight cut-off of 50-100 Daltons.

The wort produced is first processed through the nano filtration portion of the system; this batch processing takes many hours and cycles to complete. The resultant liquid that is processed through the nano filtration portion is much cleaner in color and taste—in fact, it looks almost like water (human eye can not detect it but lab analysis shows it to be slightly more brown than water) with a slight smell of malt. This batch is than processed through the reverse osmosis portion of the system and this batch processing takes many hours and cycles to complete. The liquid that is processed through reverse osmosis filtration is almost as clean as water—in color, odor and taste, and this is confirmed with lab analysis of the sample.

There are several advantages of the novel method in addition to producing a very pure and gluten-free vodka, such as less frequent cleaning of the pot still and fractional distillation equipment. With the method described herein, each batch of distillation of vodka takes about three hours, but there is almost no cleaning required between batches as the pot still is almost as clean as before the start of the distillation process. In fact, one can make almost a continuous process by simply draining the leftover in the pot still after the batch is finished as it consists of almost 100% water and immediately re-charge the pot still with next batch of feed “beer/wash”. In conventional distillation without using the clean feed “beer/wash”, after the batch is finished boiling and distilling, the left over in the pot still is dark in color and is caked/baked to the inside walls of the pot still. In the conventional distillation system, the operator has to turn off the heat source (usually steam), wait for the pot still to cool down for 2 to 3 hours as the pot still is usually heavily insulated and than open the manhole to rub and clean the inside of the pot still and the rest of the still including pipes, valves and the fractional distillation part of the system by flushing water mixed with caustic solution for another 1 or more hour. The disclosed method eliminates the extensive time required to cool down and clean the pot still between batches of distillation.

A second advantage is a reduction in labor and operating costs; since less cleaning required means lower labor costs as well as savings in energy and caustic solution. Also, with less caked brown and black debris plugging the pipes, the vales and most importantly, the packed column used for fractional distillation—whether bubble cap trays or stainless steel wave, ceramic or glass wool packing—the operating life of this equipment is greatly extended from a regular two year life when the packing material have to be replaced by shutting down the system for one to two weeks to a trouble free operation of at least ten years, This significantly reduces the maintenance and operating costs. Also, there is no need to process the final distillate i.e. vodka through a charcoal filtration system as the vodka is very clean and pure such that final polishing filtration through the charcoal filter does not do anything to improve the quality of the vodka. This reduces the capital investment needed as well as eliminates the energy, labor and the operating costs associated with operating the charcoal filtration system, which includes frequent replacement of the plugged up and worn charcoal cartridges.

A third advantage of the novel vodka production method is a reduction in energy usage. With such a clean feed “beer/wash’, the thermal efficiency of the pot still and fractional distillation column improves significantly; thereby, reducing the usage of energy and related costs. Less frequent cleaning between batches and increased life of the packed column internals also reduces the energy requirement.

A fourth advantage of the novel vodka production method is an increase in throughput of the process equipment. With increased thermal efficiency of the pot still and fractionation distillation equipment, lot less cleaning between batches, the throughput of the distillation equipment can be increased by 20 to 40%.

A fifth advantage is that having 4 of the main contaminants “congeners” (Acetone, Is-propanol, Methyl Acetate and Acetal) completely absent and a vast reduction in another congener (Methanol) from the beer/wash that is distilled. This results in a final product that is a lot more pure; in addition, the Heads and Tails portion of the batch distillation run is a lot shorter. This makes 95% of the distillation run consisting of heads when pure Vodka is produced and shortens the batch length by 25 to 40% and increases the throughput of the distillation equipment by 25 to 40%.

A sixth advantage is that the NF and RO filtration takes out all the remaining sugar and yeast from the beer/wash that is left over from the fermentation process as the fermentation process is never 100% efficient. If present in the beer/wash, the sugar components burn inside the pot still distillation equipment, the aroma travels with the ethanol vapor and gives the final vodka a smell of toffee or caramel. The leftover yeast also burns in the distillation process and release what are known as Bs which smell unpleasant and burn meat like in the final Vodka product.

The following examples are given to illustrate the process of the present invention. However, it is understood that these examples are given merely for purposes of illustration, and that the present invention is not necessarily limited thereto.

### EXAMPLES

### Example 1

### Preparation of Malt Base

Brewing was begun by grinding 9,600 pounds of pale malted barley and pneumatically moving it into the grist case. The mash/lauter tun was then filled with one hundred barrels (3,100 US Gallons) of clean potable water at one hundred twenty degrees Fahrenheit, seven (7) liters of saccharifying enzyme (glucoamylase derived from Aspergillus niger and pullulanse derived from Bacillus licheniformis) and eight (8) pounds of food grade calcium chloride. While turning the lauter rakes, the grist case was emptied into the mash tun and thoroughly mixed to ensure full saturation of the grist. The lauter rakes were then turned off and the mash is allowed to rest for twenty (20) minutes.

Steam lines providing food grade steam were then opened in the mash/lauter tun to raise the temperature of the mash to one hundred forty seven degrees Fahrenheit, while slow mixing with the lauter rakes ensures even heating. At temperature, the lauter rakes were turned off and the mash was allowed to rest for forty five (45) minutes in order to complete conversion of barley starch into simple sugars via enzymatic degradation.

The liquid portion of the mash was then drained through the bottom of the mash/lauter tun into the grant and re-circulated back on top of the mash until the liquid ran clear, approximately ten (10) minutes. Once the liquid ran clear, the diversion valve was opened and the liquid was pumped into the brew kettle.

When half the liquid was pumped into the brew kettle, sparge water was introduced onto the mash in an even pattern covering the entire mash bed. The water temperature must be at one hundred seventy (170) degrees Fahrenheit. This process rinsed the mash of any remaining residual sugars left in the grain bed. A total of two hundred fifteen barrels (6,665 US Gallons) was sparged over the mash.

When diversion of mash liquid to the brew kettle filled the kettle half full, steam valves were opened to allow steam to flow through bottom coils in the brew kettle and heat the liquid to a boil. Liquid corn syrup was added at this time, fourteen thousand four hundred (14,400) pounds 95 DE liquid dextrose. When the kettle was full, a second steam valve was opened to allow steam to flow into a side coil in the brew kettle, thereby producing heating from two sources and forcing the liquid into a swirling motion which ensured proper mixing of the liquid and adjunct syrups.

Two and one-tenth (2.1) pounds of carrageenan flocculant, one-fourth (0.25) pound food grade zinc sulfate, ten (10) pounds dessicated yeast, ten (10) pounds food grade diammonium phosphate, and twenty two and one-half (22.5) pounds of spent hops were added to the brew kettle. At this stage, the liquid became wort. The wort was boiled for sixty (60) minutes to allow for isomerization of hop acids and coagulation of proteins.

After sixty (60) minutes of boiling, the steam valves were closed and the wort was pumped into a holding tank known as a whirlpool. The wort was pumped into the whirlpool tangentially to allow insoluble proteins and vegetative matter to pool into the center of the tank. When the whirlpool was full, the wort was allowed to sit for twenty (20) minutes before cooling began, thus allowing suspended insolubles to precipitate out of solution.

Cooling the wort was accomplished through a two-stage heat exchanger. Wort flowed between stainless steel plates in opposition to water flowing through neighboring plates. This method reduced the temperature of the wort from two hundred ten (210) degrees Fahrenheit to seventy three (73) degrees Fahrenheit and raised the water temperature to one hundred seventy (170) degrees Fahrenheit. The second stage flowed wort past neighboring plates of food grade propylene glycol, reducing the wort temperature to sixty eight (68) degrees Fahrenheit. An air compressor fed filtered air to the cooled wort to provide a minimum of eight (8) parts per million oxygen content in the wort stream. Wort flows directly from the heat exchanger to a fermenter.

One (1) hour prior to beginning wort cooling, fifty (50) kilograms of proprietary dehydrated yeast was re-hydrated with eight hundred (800) liters of eighty five (85) degree Fahrenheit water and agitated in a one thousand forty four (1,044) liter stainless steel yeast brink.

Ten (10) minutes into wort cooling, yeast valves were opened to allow yeast to feed in-stream with the wort on the way to the fermenter.

Once cooling was completed, fermenter controls were set to maintain a temperature of seventy two (72) degrees Fahrenheit for the remainder of the fermentation cycle.

Daily quality assurance tests were performed to measure real extract, temperature, and pH levels. Fermentation was complete when the real extract levels drop less than one-tenth (0.1) degree Plato in twenty four (24) hours. The fermenter was crash-cooled by adjusting the controls to open coolant valves and drop the beer/wash temperature to thirty two (32) degrees Fahrenheit. Final cooling temperature was achieved in forty eight (48) hours.

The beer/wash was pumped into a storage tank for further processing.

The beer/wash was filtered into another storage tank through a diatomaceous earth filter to ten (10) micron efficiency to remove all traces of residual yeast. Nano-filter and reverse osmosis filtration through an ultra filtration system supplied by Alko International of the Netherlands completed the brew cycle.

### Example 2

### Filtration Process Procedure

The following protocol was utilized to run the filtration system, which sequentially nano filters and then filters fermentate via reverse osmosis.

### Nano-Filtration (NF):

The cartridges/membranes used for nano-filtration used were: GE Desal DK Series Industrial High Rejection thin film Nano-filtration Element. It is GE Model Number DK8040F1001. Specifications and operating parameters are as follows:
Molecular Weight cut-off of 150-300 Dalton for uncharged organic molecules
Active Area 390 sq. ft. active area
Operating pressure 30 bar
Temperature range 10 to 20 Celsius
Average Permeate Flow 7800 gpd (30 cubic meters per day)
Minimum MgSO4 rejection 98%
Typical operating Flux 5 to 20 GFD
Cross flow recirculation rate of 1148 barrels per hour
Flow from the feed tank averages 85 barrels per hour.
14 cartridges/membranes used for the system.

Reverse Osmosis Filtration (RO):
The cartridges/membranes used for Reverse Osmosis filtration used were: GE Desal AG Series thin film reverse osmosis membrane elements designed for high flux and high sodium chloride rejection. It is GE Model Number with AG8040F. Specifications and operating parameters are as follows:
Active Area 380 sq. ft. active area
Operating pressure 30 bar
Temperature range 20 to 50 Celsius
Average Permeate Flow 9600 gpd (36,3 cubic meters per day)
Average NaCL rejection 99.5%
Minimum NaCL rejection 99%
Typical Operating Flux 10 to 20 GFD
Cross flow recirculation rate of 1500 barrels per hour
Flow from the feed tank averages 150 barrels per hour.
14 cartridges/membranes used for the system.

### Nano Filtration (NF) Step

1. Turn on the water supply for the pumps (after motors are started, make sure there is water flowing to the pump seals by checking the outflow pipes off the pumps—if no water is flowing, shut down machine).
2. Touch the “Settings” button and make sure the NF button is yellow and the RO button is grey. Touching the button should turn it yellow and activate it.
3. Open the large in-feed valve for the NF and close the large in-feed valve for the RO.
4. Open the large Concentrate valve for the NF and close the Concentrate valve for the RO.
5. Open the small Permeate valve for the NF and close the Permeate valve for the RO.
6. Open the air relief valve for the NF.
7. Touch the “Production” button at the upper left of the touch screen.
8. Select Tank K13 for level control by touching that icon.
9. Ensure that there is sufficient malt base in tank K13—there should be a minimum of 500 bbls.
10. Close all manifold valves on the K-Tanks.
11. Open the main tank valve on K13
12. Open the valve ahead of the feed pump.
13. Make sure the U-Tube fitting for the concentrate line is connected to the incoming concentrate line in K-Cellar and to the line feeding Tank K13. Open the two valves on either side of this U-Tube.
14. Open the valves at the junction of the Permeate line with the large manifold pipe.
15. Open Tank K14 valve.
16. On the “Production” screen, touch the yellow rectangle labeled “Start Production”.
17.When machine is up to full power (Running), take hourly readings on the following areas:
   TMP pressure difference membrane (TMP)
   SP system pressure (PI 0501)
   Permeate flow (FL 0701)
   Concentrate flow (FL 0801)
   Cross flow (FL 0501
   System temperature (TI 0201)
18. System will shut down automatically when system temperature or TMP (trans-membrane pressure) becomes too high, or system can be shut down by flowing the shut down procedure
Shutdown procedures for Ultra Filter NF
   1. Ensure that the screen labeled “Production” is showing. If not, touch the “Production” button at the upper left of the touch screen.
   2. Touch the red rectangle labeled “Stop Production”.
   3. A window will pop up asking “Do You Want To Stop Production?” with two small rectangles, in opposite corners, labeled “Yes” and “No”.
   4. Touch the “Yes” button.
   5. The pumps will begin to power down—this process should take about ten minutes.
   6. Once the pumps have powered down completely, close all tank and line valves in K-Cellar

After completion of the NF step, at reference numeral 2 of FIG. 1, concentrate and NF permeate will be fed to the Reverse Osmosis Filtration Step.

### Reverse Osmosis Filtration (RO) Step

1. Turn on the water supply for the pumps (after motors are started, make sure there is water flowing to the pump seals by checking the outflow pipes off the pumps—if no water is flowing, shut down machine).
2. Touch the “Settings” button and make sure the RO button is yellow and the NF button is grey. Touching the button should turn it yellow and activate it.
3. Open the large in-feed valve for the RO and close the large in-feed valve for the NF.
4. Open the large Concentrate valve for the RO and close the Concentrate valve for the NF.
5. Open the small Permeate valve for the RO and close the Permeate valve for the NF.
6. Open the air relief valve for the RO.
7. Touch the “Production” button at the upper left of the touch screen.
8. Select Tank K14 for level control by touching that icon.
9. Ensure that there is sufficient malt base in tank K14—there should be a minimum of 500 bbls.
10. Close all manifold valves on the K-Tanks.
11. Open the main tank valve on K14
12. Open the valve ahead of the feed pump.
13. Make sure the U-Tube fitting for the concentrate line is connected to the incoming concentrate line in K-Cellar and to the line feeding Tank K14. Open the two valves on either side of this U-Tube.
14. Open the valves at the junction of the Permeate line with the large manifold pipe.
15. Open Tank K15 valve.
16. On the “Production” screen, touch the yellow rectangle labeled “Start Production”.
17. When machine is up to full power (Running), take hourly readings on the following areas:
   TMP pressure difference membrane (TMP)
   SP system pressure (PI 0501)
   Permeate flow (FL 0701)
   Concentrate flow (FL 0801)
   Cross flow (FL 0501
   System temperature (TI 0201)
   System will shut down automatically when system temperature or TMP (trans-membrane pressure) becomes too high, or system can be shut down by flowing the shut down procedure

### Reverse Osmosis Filtration (RO) Shutdown Step

Shutdown procedures for Ultra Filter RO
   1. Ensure that the screen labeled “Production” is showing. If not, touch the “Production” button at the upper left of the touch screen.
   2. Touch the red rectangle labeled “Stop Production”.
   3. A window will pop up asking “Do You Want To Stop Production?” with two small rectangles, in opposite corners, labeled “Yes” and “No”.
   4. Touch the “Yes” button.
   5. The pumps will begin to power down—this process should take about ten minutes.
   6. Once the pumps have powered down completely, close all tank and line valves in K-Cellar.

Subsequent to filtration, the final beer/wash is obtained for distillation at reference numeral 4 of FIG. 1.

### Example 3

### Gluten Analysis

A gluten analysis of the feed “beer/wash” before (Sample 2) and after (Sample 1) it has gone through the filtration process of the present invention was performed. These lab analyses were done using the most stringent method available. Competitive R5 ELISA (R7011 Gliadin Competitive): a competitive enzyme-linked immunosorbent assay based on the R5 monoclonal antibody to the potentially celiac toxic epitope (ie, antibody-binding site) QQPFP (glutamine-glutamine-proline-phenylalanine-proline). The competitive ELISA requires only one epitope to work. As a result, this ELISA is intended to be used on products containing hydrolyzed ingredients, such as malt/beer/wash, that have been broken down into smaller protein fragments.

Sample 2 which is the feed “beer/wash” used by the conventional distillation for vodka was found to have a gluten content of 136.7 ppm (parts per million) and Sample 1 which is the feed “beer/wash” used as a result of processing with filtration for distillation for vodka has ND (Not Detectable) gluten content. It should also be noted that current Codex Standard for Gluten Free products is 20 ppm maximum. This again indicates the benefit of using the combined nanofiltration and reverse osmosis filtration in the production method as the vodka produced is guaranteed to be gluten free and free from almost all other contaminants.

### Example 4

### Comparative Testing

Comparative tests were run to illustrate the superior properties of product vodkas produced by the process. The first analysis was that of the wort before it is processed through the combined filtration system. It has a real extract of 1.12 (indicator of brown malt/solids suspended in liquid), color of 4.86 and Brix (indicator of sweetness) of 8.4. For comparison, these parameters are the same as that of a regular beer/wash. This is the feed “beer/wash” used in conventional systems for distillation in the production of vodka.

The second analysis shows typical analysis after the batch has been processed through the nanofiltration portion of the apparatus. It should be noted that the real extract (indicator of brown malt/solids suspended in liquid) has gone down from 1.12 to 0.32—a drop in excess of 70%, color has gone down from 4.86 to 0.55—a drop in excess of 85% and Brix (indicator of sweetness) have gone down from of 8.4 to 6.8—drop of 25%.

The third analysis shows typical analysis after the batch has been processed through the reverse osmosis filtration portion of the apparatus. It should be noted that the real extract (indicator of brown malt/solids suspended in liquid) has gone down from 1.12 to 0.03—a drop of almost 100% which means the liquid has almost no suspended materials, color has gone down from 4.86 to 0.12—which means the liquid is very very close to cleanest water one can create and Brix (indicator of sweetness) have gone down from of 8.4 to 4.5. This is the feed “beer/wash” used as a result of the disclosed method for distillation in producing the cleanest and purest vodka.

TABLE 1

| | |
|---|---|
| Feed “Beer/wash” | Feed “Beer/wash” |
| used | used |
| For Distillation | For Distillation |
| Without The | With The Disclosed |
| Disclosed Method | Method |

| Neutral Malt Base | Conventional | Nano- | |
|---|---|---|---|
| Analyses | filtration | Filtered | RO Filtered |
| Specific Gravity | 0.9934 | 0.9907 | 0.985 |
| Alcohol by Volume | 16.2 | 16.1 | 15.95 |
| Real Extract | 1.12 | 0.32 | 0.03 |
| Color | 4.86 | 0.55 | 0.12 |
| Brix | 8.4 | 6.8 | 4.5 |

The table below shows HPLC (High performance Liquid Chromatography) Analysis of the 3 samples, showing the reduction in sugars and other contaminants in the beer/wash that will be distilled as a result of the disclosed method. If the same method was used for a molasses based beer/wash that is used by rum manufacturers, it will have much more of the sugars and contaminants to start with and will result in very little sugars and contaminants in the liquid that can be distilled to produce pure Vodka.

| | | | Post Reverse |
|---|---|---|---|
| | Pre-Nano | Post Nano- | Osmosis |
| | Filtration | Filtration | Filtration |
| | Sample | Sample | Sample |
| | % age | % age | % age |
| DP4+ (Maltotetraose plus) | 2.69 | 0.53 | Not Detectable |
| DP3 (Maltotroise) | 2.01 | 0.5 | Not Detectable |
| Maltose | 7.65 | 1.55 | Not Detectable |
| Dextrose | 1.04 | 1.24 | 0.48 |
| Succinic Acid | 0.68 | 0.57 | 0.17 |
| Lactic Acid | 0.14 | 0.13 | Not Detectable |
| Glycerol | 8.63 | 8.33 | 2.65 |
| Acetic Acid | 0.2 | 0.29 | 0.76 |

The analysis below shows Gas Chromatograph Analysis of the 3 samples, showing the reduction in Heads, Tails and Esters in the beer/wash that will be distilled as a result of the disclosed method. If the method was used for a molasses based beer/wash that is used by rum manufacturers, it will have about 2 to 5 more times of the Heads, tails and contaminants to start with and will result in all these contaminants taken out; thereby reducing the heads and tails portion of the distillation run.

| | | | Post Reverse |
|---|---|---|---|
| | Pre-Nano | Post Nano- | Osmosis |
| | Filtration | Filtration | Filtration |
| | Sample | Sample | Sample |
| | mg/100 mL | mg/100 mL | mg/100 mL |
| | Pure Alcohol | Pure Alcohol | Pure Alcohol |
| Heads (Low Alcohols) | | | |
| Acetaldehyde | 7.56 | 5.2 | 4.1 |
| Methanol | 1.43 | 1.31 | 1.31 |
| Acetone | 1.1 | Not Detectable | Not Detectable |
| Tails (Low Alcohols/ | | | |
| Fusel Oils) | | | |
| Iso-propanol | 1.3 | Not Detectable | Not Detectable |
| N-Propanol | 43.2 | 36.5 | 35.6 |
| Iso-Butanol | 32.2 | 24.2 | 22.6 |
| Acetal | 1.3 | Not Detectable | Not Detectable |
| Iso-Pentanol | 200.3 | 150.3 | 124.7 |
| Esters | | | |
| Methyl Acetate | 2.1 | Not Detectable | Not Detectable |
| Ethyl Acetate | 36.2 | 21.1 | 21.1 |

In addition, the lab analysis for Gluten content using the ELISA RBR Gliadin Competitive method, which is the most stringent method of analysis for hydrolyzed glutens in a liquid shows that we are able to reduce from a gluten content of 131.7 ppm in the beer/wash from the conventional method down to Not Detectable, by using the disclosed method.

Variations of the present invention have been described with reference to certain embodiments that are intended to be exemplary only and not limiting to the full scope of the present invention as set forth in the appended claims. It should be understood that various changes and modifications to the present invention will be apparent to those skilled in the art. Such changes and modifications can be made without departing from the spirit and scope of the invention and without diminishing its intended advantages. It is therefore intended that such changes and modifications be covered by the appended claims.

The claimed invention is:

1. A method of producing vodka comprising the steps of:
a) fermenting a wort to obtain a fermentate;
b) cooling the fermentate;
c) filtering the cooled fermentate through nano filtration and reverse osmosis filtration to obtain a purified fermentate; and then
d) distilling said purified fermentate to obtain vodka.

2. The method of claim 1 without charcoal filtration.

3. The method of claim 1 wherein said filtrate is filtered sequentially through nano filtration and then through reverse osmosis filtration.

4. The method of claim 1 wherein said fermentate is cooled in a two-stage heat exchanger.

5. A method of producing gluten-free vodka from a gluten grain source comprising the steps of:
a) fermenting a wort produced from a gluten grain source to obtain a fermentate;
b) cooling the fermentate;
c) filtering the cooled fermentate through nano filtration and reverse osmosis filtration to obtain a purified fermentate; and then
d) distilling said purified fermentate to obtain vodka 100% free of gluten.

6. The method of claim 5 wherein said gluten grain source is barley.

7. The method of claim 5 without charcoal filtration.

8. The method of claim 5 wherein said filtrate is filtered sequentially through nano filtration and then through reverse osmosis filtration.

9. The method of claim 5 wherein said fermentate is cooled in a two-stage heat exchanger.

10. A method of producing a fermentate for subsequent distillation comprising:
a) fermenting a wort to obtain a first fermentate such that the first fermentate has a specific gravity of 0.9934 or greater, alcohol by volume of 16.2 or greater, real extract of 1.12 or higher, color of 4.86 or greater and Brix of 8.4 or greater;
b) filtering to form a second fermentate such that the second fermentate has a specific gravity of 0.9907 or less, alcohol by volume of 16.1 or less, real extract of 0.32 or less, color of 0.55 or less and Brix of 6.8 or less.

11. The method of producing a fermentate for subsequent distillation of claim 10 further comprising:
a) said filtering step being a first filtering step;
b) after said first filtering step and before said distilling step, performing a second filtering step to form a third fermentate such that the third fermentate has a specific gravity of 0.985 or less, alcohol by volume of 15.95 or less, real extract of 0.03 or less, color of 0.12 or less and Brix of 4.5 or less.

12. The method of producing a fermentate for subsequent distillation of claim 11 further comprising distilling said second fermentate to form a vodka.

13. The method of producing a fermentate for subsequent distillation of claim 10 further comprising:
a) prior to said filtering step said first fermentate comprises DP4+ (Maltotetraose plus) of 2.69 or higher, DP3 (Maltotroise) of 2.01 or higher, Maltose of 7.65 or higher, Succinic Acid of 0.68 or higher, Lactic Acid of 0.14 or higher, Glycerol of 8.63 or higher and Acetic Acid of 0.2 or higher;
b) after said filtering step said second fermentate comprises DP4+ (Maltotetraose plus) of 0.53 or lower, DP3 (Maltotroise) of 0.5 or lower, Maltose of 1.55 or lower, Dextrose of 1.24 or lower, Succinic Acid of 0.57 or lower, Lactic Acid of 0.13 or lower, Glycerol of 8.33 or lower and Acetic Acid of 0.29 or higher.

14. The method of producing a fermentate for subsequent distillation of claim 13 further comprising:
a) said filtering step being a first filtering step;
b) after said first filtering step performing a second filtering step to form a third fermentate such that the third fermentate has a specific gravity of 0.985 or less, alcohol by volume of 15.95 or less, real extract of 0.03 or less, color of 0.12 or less and Brix of 4.5 or less.
c) said third fermentate comprises DP4+ (Maltotetraose plus) at an undetectable level, DP3 (Maltotroise) at an undetectable level, Maltose at an undetectable level, Dextrose of 0.48 or lower, Succinic Acid of 0.17 or lower, Lactic Acid at an undetectable level, Glycerol of 2.65 or lower and Acetic Acid of 0.76 or higher.

15. The method of producing a fermentate for subsequent distillation of claim 14 further comprising:
a) prior to said filtering step said first fermentate comprises, in mg/100 ml Pure Alcohol,
i. Heads (Low Alcohols) of Acetaldehyde 7.56 or higher, Methanol of 1.43 or higher, Acetone of 1.1 or higher
ii. Tails (Low Alcohols/Fusel Oils) of Iso-propanol of 1.3 or higher, N-Propanol of 43.2 or higher, Iso-Butanol of 32.2 or higher, Acetal of 1.3 or higher, Iso-Pentanol of 200.3 or higher;
iii. Esters of Methyl Acetate of 2.1 or higher and Ethyl Acetate of 36.2 or higher;
b) filtering to form a second fermentate such that the second fermentate comprises in mg/100 ml Pure Alcohol,
i. Heads (Low Alcohols) of Acetaldehyde 5.2 or lower, Methanol of 1.31 or lower, Acetone at an undetectable level;
ii. Tails (Low Alcohols/Fusel Oils) of Iso-propanol at an undetectable level, N-Propanol of 36.5 or lower, Iso-Butanol of 24.2 or lower, Acetal at an undetectable level, Iso-Pentanol of 150.3 or lower;
iii. Esters of Methyl Acetate at an undetectable level and Ethyl Acetate of 21.1 or lower.

16. The method of producing a fermentate for subsequent distillation of claim 15 further comprising:
a) said filtering step being a first filtering step;
b) after said first filtering step performing a second filtering step to form a third fermentate such that the third fermentate has a specific gravity of 0.985 or less, alcohol by volume of 15.95 or less, real extract of 0.03 or less, color of 0.12 or less and Brix of 4.5 or less,
c) said third fermentate comprises DP4+ (Maltotetraose plus) at an undetectable level, DP3 (Maltotroise) at an undetectable level, Maltose at an undetectable level, Dextrose of 0.48 or lower, Succinic Acid of 0.17 or lower, Lactic Acid at an undetectable level, Glycerol of 2.65 or lower and Acetic Acid of 0.76 or higher
d) said third fermentate further comprises,
i. Heads (Low Alcohols) of Acetaldehyde 4.1 or lower;
ii. Tails (Low Alcohols/Fusel Oils) of N-Propanol of 35.6 or lower, Iso-Butanol of 22.2 or lower, Iso-Pentanol of 124.7 or lower.

17. The method of producing a fermentate for subsequent distillation of claim 10 further comprising:
a) fermenting a wort to obtain a first fermentate such that the first fermentate has:
a. a specific gravity of 0.9934 or greater, alcohol by volume of 16.2 or greater, real extract of 1.12 or higher, color of 4.86 or greater and Brix of 8.4 or greater;
b. DP4+ (Maltotetraose plus) of 2.69 or higher, DP3 (Maltotroise) of 2.01 or higher, Maltose of 7.65 or higher, Succinic Acid of 0.68 or higher, Lactic Acid of 0.14 or higher, Glycerol of 8.63 or higher and Acetic Acid of 0.2 or higher;
c. in mg/100 ml Pure Alcohol,
i. Heads (Low Alcohols) of Acetaldehyde 7.56 or higher, Methanol of 1.43 or higher, Acetone of 1.1 or higher
ii. Tails (Low Alcohols/Fusel Oils) of Iso-propanol of 1.3 or higher, N-Propanol of 43.2 or higher, Iso-Butanol of 32.2 or higher, Acetal of 1.3 or higher, Iso-Pentanol of 200.3 or higher;
iii. Esters of Methyl Acetate of 2.1 or higher and Ethyl Acetate of 36.2 or higher;
b) filtering to form a second fermentate such that the second fermentate has
a. a specific gravity of 0.9907 or less, alcohol by volume of 16.1 or less, real extract of 0.32 or less, color of 0.55 or less and Brix of 6.8 or less;
b. DP4+ (Maltotetraose plus) of 0.53 or lower, DP3 (Maltotroise) of 0.5 or lower, Maltose of 1.55 or lower, Dextrose of 1.24 or lower, Succinic Acid of 0.57 or lower, Lactic Acid of 0.13 or lower, Glycerol of 8.33 or lower and Acetic Acid of 0.29 or higher;
c. in mg/100 ml Pure Alcohol,
i. Heads (Low Alcohols) of Acetaldehyde 5.2 or lower, Methanol of 1.31 or lower, Acetone at an undetectable level;
ii. Tails (Low Alcohols/Fusel Oils) of Iso-propanol at an undetectable level, N-Propanol of 36.5 or lower, Iso-Butanol of 24.2 or lower, Acetal at an undetectable level, Iso-Pentanol of 150.3 or lower;
iii. Esters of Methyl Acetate at an undetectable level and Ethyl Acetate of 21.1 or lower;
c) said filtering step being a first filtering step;
d) after said first filtering step performing a second filtering step to form a third fermentate such that the third fermentate has
a. a specific gravity of 0.985 or less, alcohol by volume of 15.95 or less, real extract of 0.03 or less, color of 0.12 or less and Brix of 4.5 or less.
b. DP4+ (Maltotetraose plus) at an undetectable level, DP3 (Maltotroise) at an undetectable level, Maltose at an undetectable level, Dextrose of 0.48 or lower, Succinic Acid of 0.17 or lower, Lactic Acid at an undetectable level, Glycerol of 2.65 or lower and Acetic Acid of 0.76 or higher
c. in mg/100 mL Pure Alcohol:
i. Heads (Low Alcohols) of Acetaldehyde 4.1 or lower;
ii. Tails (Low Alcohols/Fusel Oils) of N-Propanol of 35.6 or lower, Iso-Butanol of 22.2 or lower, Iso-Pentanol of 124.7 or lower.

18. The method of producing a fermentate for subsequent distillation of claim 17 further comprising distilling said third fermentate to form a vodka.

19. The method of producing a fermentate for subsequent distillation of claim 17 further comprising
a) said first filtration step being nano-filtration
b) said second filtration step being reverse osmosis filtration.

20. The method of producing a fermentate for subsequent distillation of claim 19 further comprising distilling said third fermentate to form a vodka.
